(19) United States
(12) Patent Application Publication
(10) Pub. No.: US 2025/0333301 A1
(43) Pub. Date: Oct. 30, 2025

(54) METHODS OF PRODUCING HYDROGEN

(71) Applicant: Saudi Arabian Oil Company, Dhahran (SA)

(72) Inventors: Xiaoxing Wang, Houston, TX (US); Feng Liang, Houston, TX (US)

(73) Assignee: Saudi Arabian Oil Company, Dhahran (SA)

(21) Appl. No.: 18/649,566

(22) Filed: Apr. 29, 2024

(51) Int. Cl. C01B 3/38

(52) U.S. Cl. CPC C01B 3/388; C01B 2203/0233; C01B 2203/0261; C01B 2203/0277; C01B 2203/10

(57) ABSTRACT

A method of producing H₂ may include passing a hydrocarbon feed into a reactor, wherein the hydrocarbon feed comprises at least 50 mol. % methane. The method may also include contacting the methane with a catalyst in the reactor to form a product comprising H₂. The catalyst may comprise a support and one or more catalytically-active metals. At least 99 wt. % of the one or more catalytically-active metals may be present in the catalyst as single-atoms, based on a total weight of the one or more catalytically-active metals in the catalyst.

### FIELD

The embodiments described herein general relate to hydrogen gas production and, more particularly to hydrogen gas production using catalysts.

### BACKGROUND

Molecular hydrogen, hereinafter referred to interchangeably as hydrogen, hydrogen gas, or H₂ has widespread uses in many diverse industries. Industries desiring hydrogen include the chemical processing industry and energy industry. In the energy industry, H₂ may be used as a clean energy fuel by the combustion of H₂ producing water. Further, H₂ may generate higher chemical energy per unit mass than typical liquid hydrocarbons.

### SUMMARY

Embodiments of the present disclosure are directed to methods of producing H₂. In particular, the methods of producing H₂ may include converting methane to hydrogen by contact with a specialized catalyst, disclosed herein. In particular, the catalyst may include one or more catalytically-active metals, where at least 99 wt. % of the one or more catalytically-active metals are present in the catalyst as single-atoms. By having a relatively great amount of the one or more catalytically-active metals in the form of single-atoms, the catalyst may have improved catalytic performance compared to conventional catalysts, such as those that include metal nanoparticles on a support. Accordingly, the methods of the present disclosure may provide enhanced conversion of methane to hydrogen as compared to conventional methods.

According to one or more embodiments, a method of producing H₂ may comprise: passing a hydrocarbon feed into a reactor, wherein the hydrocarbon feed comprises at least 50 mol. % methane; contacting the methane with a catalyst in the reactor to form a product comprising H₂, wherein the catalyst comprises a support and one or more catalytically-active metals, and wherein at least 99 wt. % of the one or more catalytically-active metals are present in the catalyst as single-atoms, based on a total weight of the one or more catalytically-active metals in the catalyst.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying claims, or recognized by practicing the described embodiments.

### DETAILED DESCRIPTION

One or more embodiments presently described herein are directed to methods of producing H₂. According to the methods of producing H₂ described herein, in general, a hydrocarbon feed comprising methane may be passed into a reactor and the methane may contact a catalyst in the reactor to form a product comprising H₂. These steps, as well as the catalyst utilized by these methods, are discussed in detail hereinbelow.

As described herein, a hydrocarbon feed comprising methane may be passed into a reactor. The hydrocarbon feed, as described herein, is the feed that contacts the catalyst in the reactor, and may be a mixture of one or more separate feed streams passed to the reactor. The hydrocarbon feed, as described herein, may include hydrocarbons and additionally non-hydrocarbons, such as carbon dioxide.

In embodiments, the hydrocarbon feed may comprise greater than or equal to 50 mol. % methane, based on the total moles of the hydrocarbon feed. For instance, in embodiments, the hydrocarbon feed may comprise methane in an amount of greater than or equal to 55 mol. %, greater than or equal to 60 mol. %, greater than or equal to 65 mol. %, greater than or equal to 70 mol. %, greater than or equal to 75 mol. %, greater than or equal to 80 mol. %, greater than or equal to 85 mol. %, greater than or equal to 90 mol. %, greater than or equal to 95 mol. %, greater than or equal to 99 mol. %, or even 100 mol. %, based on the total moles of the hydrocarbon feed. In embodiments, the hydrocarbon feed may comprise less than or equal to 99 mol. %, less than or equal to 95 mol. %, less than or equal to 90 mol. %, less than or equal to 85 mol. %, less than or equal to 80 mol. %, less than or equal to 75 mol. %, or less than or equal to 70 mol. % of methane, based on the total moles of the hydrocarbon feed.

In embodiments, the hydrocarbon feed may comprise from 0 mol. % to 10 mol. % ethane, such as from 0 mol. % to 2 mol. %, from 2 mol. % to 4 mol. %, from 4 mol. % to 6 mol. %, from 6 mol. % to 8 mol. %, from 8 mol. % to 10 mol. %, or from any and all ranges and sub-ranges between the foregoing values, based on the total moles of the hydrocarbon feed.

In embodiments, the hydrocarbon feed may comprise from 0 mol. % to 50 mol. % carbon dioxide (CO₂), such as from 0 mol. % to 5 mol. %, from 5 mol. % to 10 mol. %, from 10 mol. % to 15 mol. %, from 15 mol. % to 20 mol. %, from 20 mol. % to 25 mol. %, from 25 mol. % to 30 mol. %, from 30 mol. % to 35 mol. %, from 35 mol. % to 40 mol. %, from 40 mol. % to 45 mol. %, from 45 mol. % to 50 mol. %, or from any and all ranges and sub-ranges between the foregoing values, based on the total moles of the hydrocarbon feed.

In embodiments, the hydrocarbon feed may comprise, consist essentially of, or consist of natural gas, which is widely available in industry as a feedstock. In embodiments, the hydrocarbon feed may comprise, consist essentially of, or consist of biogas. As used herein, “biogas” refers to a gaseous fuel produced by the fermentation of organic matter.

In embodiments, the hydrocarbon feed may be processed prior to passing the hydrocarbon feed to the reactor. For instance, the hydrocarbon feed may be passed to a separator prior to passing the hydrocarbon feed to the reaction. As used in the present disclosure, the terms “separation unit” and “separator” refer to any separation device(s) that at least partially separates one or more chemical constituents in a mixture from one another. For example, a separation system selectively separates different chemical constituents from one another, forming one or more chemical fractions. Examples of separation systems include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, or combinations of these. The separation processes described in the present disclosure may not completely separate all of one chemical constituent from all of another chemical constituent. Instead, the separation processes described in the present disclosure “at least partially” separate different chemical constituents from one another and, even if not explicitly stated, separation can include only partial separation. In embodiments, the hydrocarbon feed may be passed directly to the reactor without any additional processing.

As described hereinabove, the catalyst may comprise a support and one or more catalytically-active metals. In embodiments, the catalyst may comprise from 80 wt. % to 99 wt. % of the support, such as from 80 wt. % to 85 wt. %, from 85 wt. % to 90 wt. %, from 90 wt. % to 95 wt. %, from 95 wt. % to 99 wt. %, or from any and all ranges and sub-ranges between the foregoing values, based on a total weight of the catalyst. In embodiments, the catalyst may comprise from 1.0 wt. % to 20.0 wt. % of the one or more catalytically-active metals, such as from 1.0 wt. % to 2.5 wt. %, from 2.5 wt. % to 5.0 wt. %, from 5.0 wt. % to 7.5 wt. %, from 7.5 wt. % to 10.0 wt. %, from 10.0 wt. % to 12.5 wt. %, from 12.5 wt. % to 15.0 wt. %, from 15.0 wt. % to 17.5 wt. %, from 17.5 wt. % to 20.0 wt. %, or from any and all ranges and sub-ranges between the foregoing values, based on a total weight of the catalyst. The support may provide a surface for the one or more catalytically-active metals to be dispersed in the catalyst. Without intending to be bound by any particular theory, it is believed that that the support may also provide physical and/or chemical sites for adsorption of the reactant, such as methane and desorption of the product, such as H₂.

In embodiments, the support may comprise a metal oxide, a mixed oxide, a carbon-based material, a metal-organic framework, or combinations thereof. In one or more embodiments, the support may comprise a metal oxide, such as but not limited to Al₂O₃, SiO₂, TiO₂, ZrO₂, CeO₂, MgO, MgAl₂O₃, or combinations thereof. In additional embodiments, the support may comprise a mixed oxide, such as but not limited to SiO₂—Al₂O₃, ZrO₂—Al₂O₃, CeO₂—Al₂O₃, ZrO₂—TiO₂, CeO₂—TiO₂, ZrO₂—SiO₂, CeO₂—SiO₂, or combinations thereof. In yet additional embodiments, the support may comprise a carbon-based material, such as but not limited to amorphous carbon, carbon black, activated carbon, graphene, graphene oxide, carbon nanotubes (CNTs), carbon nanofibers (CNFs), graphite, or combinations thereof. In additional embodiments, the support may comprise a metal-organic framework.

As described hereinabove, the catalyst may comprise one or more catalytically-active metals. As used herein, the “one or more catalytically-active metals” refers to a metal operable to catalyze the decomposition of methane to form H₂. The one or more catalytically-active metals, in general, may be single metal atoms and not refer to metal oxides.

In embodiments, at least 99 wt. % of the one or more catalytically-active metals may be present in the catalyst as single-atoms, based on a total weight of the one or more catalytically-active metals in the catalyst. As used herein, “single-atoms” of the one or more catalytically-active metals in the catalyst refers to an atom of the one or more catalytically-active metals distanced at least 5 angstroms (Å) from every other identical atom of the one or more catalytically-active metals. That is, in embodiments, the one or more catalytically-active metals present in the catalyst as single-atoms may not include metal clusters or nanoparticles of the one or more catalytically-active metals. It should be understood that the one or more catalytically-active metals present in the catalyst as single-atoms may be bound to the support, and the support may include other catalytically-active metals. That is, in embodiments, the catalyst may include a first catalytically-active metal, wherein at least 99 wt. % of the first catalytically-active metal is present as single atoms, and the catalyst may include a second catalytically-active metal that may include metal clusters or nanoparticles.

Without being bound by any particular theory, it is believed that the greater amount of the one or more catalytically-active metals in the form of single-atoms in the embodiments described herein may alter the metal coordination environment, introduce a quantum size effect, and/or improve metal-support interactions, thereby improving the catalytic performance of the catalyst for converting methane to H₂. In conventional embodiments, such as catalysts that include nanoparticles, the catalysts may require higher reaction temperatures because of a high activation energy of the catalyst, or may suffer from faster catalyst deactivation due to metal sintering, carbon encapsulation, or metal migration. Accordingly, the methods of the present disclosure may provide improved conversion of methane to H₂ compared to conventional methods.

The total amount of the one or more catalytically-active metals present as single-atoms in the catalyst may be quantified by inductively coupled plasma optical emission spectroscopy (ICP-OES) and/or inductively coupled plasma mass spectroscopy (ICP-MS) The presence of single atoms in the catalyst may be confirmed by transmission electron microscopy (TEM).

In embodiments, the one or more catalytically-active metals may comprise, consist essentially of, or consist of one or more of Co, Cr, Fe, Mn, Mo, Ni, Cu, Zn, Ru, Rh, Pd, Ag, Re, Ir, Pt, Pd, or Au. In some embodiments, the one or more catalytically-active metals may comprise, consist essentially of, or consist of one or more of Co, Cr, Fe, Mn, Mo, Ni, Cu, Zn, Ru, Rh, Pd, Ag, Re, Ir, Pt, or Pd. That is, in embodiments, the one or more catalytically-active metals may not comprise Au.

In embodiments, the catalyst may comprise one or more catalyst promoters. The catalyst promoter may improve the selectivity, durability, and/or the activity of the catalyst. In embodiments, the catalyst promotor may strengthen the interaction between the support and the one or more catalytically-active metals. The catalyst promoter may be a chemical promoter, a structural promoter, or both. Without intending to be bound by any particular theory, it is believed, in embodiments, that the chemical promoter may improve the efficiency of the catalyst by altering the distribution of electrons at the surface of catalyst. Without intending to be bound by any particular theory, it is believed that that the chemical promoter may provide physical and/or chemical sites for adsorption of the reactant, such as methane, and desorption of the product, such as H₂. Further, in embodiments, it is believed that the chemical promoter may strengthen the interactions between the one or more catalytically-active metals and the support, which may increase the stability of the catalyst during the reaction. Without intending to be bound by any particular theory, it is believed that the structural promoter may improve the mechanical properties of the catalyst, which may reduce or prevent attrition of the catalyst when used in certain reaction processes, such as in a fluidized-bed operation.

In some embodiments, the catalyst promoter may comprise, consist essentially of, or consist of one or more of alkali metals, Ce, Ce₂O₃, CeO₂, Mg, MgO, Ca₂SiO₄, CaO, La, Nd, Gs, or Re. In embodiments, the catalyst promoter may comprise, consist essentially of, or consist of one or more of alkali metals, Ce, Ce₂O₃, CeO₂, Mg, MgO, Ca₂SiO₄, CaO, La, Nd, or Gs. In embodiments, the catalyst promoter may not include single-atoms.

In additional embodiments, the catalyst may comprise from 0.1 wt. % to 20 wt. % of the catalyst promoters, such as one or more of alkali metals, Ce, Ce₂O₃, CeO₂, Mg, MgO, Ca₂SiO₄, CaO, La, Nd, Gs, or Re, based on a total weight of the catalyst.

In one or more embodiments, defects may be introduced to the support, which may improve the catalytic activity of the catalyst. Without intending to be bound by any particular theory, it is believed that defects may be introduced to the support, thereby affecting properties of the catalyst, such as the thermal, optical, magnetic, or mechanical properties, which may affect the adsorption and desorption of reactants and products on the catalyst. The concentration, distribution, and types of defects on the support may be selected to influence the catalytic activity of the catalyst. In embodiments, the defects may be introduced in the support during the synthesis of the catalyst. Non-limiting examples of defects that may be introduced in the support may include surface atom vacancy, such as oxygen vacancy, nitrogen vacancy, or carbon vacancy, surface heteroatomic bonding, such as nitrogen bonding, oxygen bonding, or carbon bonding, structure distortion, surface step, edge defects, stacking fault, holes, or combinations thereof.

In embodiments, the catalyst may comprise a plurality of defects. An amount of the defects present in the catalyst may be modified by chemical and/or thermal treatment of the catalyst.

The catalysts used in the methods described herein may be synthesized using methods such as but not limited to co-precipitation, high temperature pyrolysis, atomic layer deposition (ALD), one-pot synthesis, or electrodeposition. In embodiments that include co-precipitation, the support, the one or more catalytically-active metals, and optionally the one or more catalyst promoters may be coprecipitated from precursors, followed by treatment, separation, and calcination to form the catalyst. In embodiments that include high temperature pyrolysis, the precursors may be heated in an inert environment to thermally decompose the precursors and form the catalyst. In embodiments that include atomic layer deposition, the one or more catalytically-active metals may be deposited on a surface of the support through the chemical adsorption of gas precursors on the support. In embodiments that include a one-pot synthesis, the catalyst may be synthesized using precursors and multi-stage reactions that may not include an intermediate separation step. In embodiments that include electrodeposition, the potential, composition of electrolytic liquid, precursor concentration, and deposition time may be modified to control the formation of the catalyst.

In embodiments, the method may further comprise pre-treating the catalyst prior to the contacting of the catalyst with the methane. In embodiments, the pre-treating may reduce the catalyst, which may increase the catalytic efficiency of the catalyst in subsequent processes, such as the production of H₂ from methane. The pre-treating may include exposing the catalyst to a pre-treatment gas at an elevated temperature, such as greater than or equal to 500° C. In embodiments, the pre-treating may comprise exposing the catalyst to the pre-treatment gas at a temperature of from 500° C. to 550° C., from 550° C. to 600° C., from 600° C. to 650° C., from 650° C. to 700° C., or from any and all ranges and sub-ranges between the foregoing values. In embodiments, the pre-treatment gas may comprise H₂ in an amount greater than or equal to 10 vol. %, greater than or equal to 25 vol. %, greater than or equal to 50 vol. %, greater than or equal to 75 vol. %, greater than or equal to 90 vol. %, greater than or equal to 95 vol. %, or greater than or equal to 99 vol. %, based on a total volume of the pre-treatment gas. In embodiments, the pre-treatment gas may comprise CO in an amount greater than or equal to 10 vol. %, greater than or equal to 25 vol. %, greater than or equal to 50 vol. %, greater than or equal to 75 vol. %, greater than or equal to 90 vol. %, greater than or equal to 95 vol. %, or greater than or equal to 99 vol. %, based on a total volume of the pre-treatment gas. In embodiments, the pre-treating may comprise exposing the catalyst to the pre-treatment gas at a temperature of from 500° C. to 700° C.

As described herein, the method may include utilizing a reactor. As used in this disclosure, a “reactor” refers to a vessel in which one or more chemical reactions may occur between one or more reactants in the presence of one or more described catalysts. For example, a reactor may include a tank or tubular reactor configured to operate as a batch reactor or continuous feed reactor. Example reactors include packed bed reactors such as fixed bed reactors, and fluidized bed reactors. Reactors, as described herein, may include a series of separate reactors. Additionally, reactors may include separation devices, such as those which separate catalyst from the reaction product. Such reactors may also include catalyst regeneration sections, as would be understood by those skilled in the art.

In embodiments, the reactor may be operated at an elevated temperature, such as from 300° C. to 1,000° C. during the contacting of the methane with the catalyst. In embodiments, the reactor may be operated at a temperature of from 300° C. to 350° C., from 350° C. to 400° C., from 400° C. to 450° C., from 450° C. to 500° C., from 500° C. to 550° C., from 550° C. to 600° C., from 600° C. to 650° C., from 650° C. to 700° C., of from 700° C. to 750° C., from 750° C. to 800° C., from 800° C. to 850° C., from 850° C. to 900° C., from 900° C. to 950° C., from 950° C. to 1,000° C., or from any and all ranges and sub-ranges between the foregoing values.

In embodiments, the reactor may be operated with a residence time from 0.1 seconds to 60 seconds. In embodiments, the reactor may be operated with a residence time from 0.1 seconds to 30 seconds, from 0.1 seconds to 60 seconds, from 20 seconds to 40 seconds, or from 30 seconds to 60 seconds.

In embodiments, the reactor may be operated at a pressure from 1 bar to 25 bar. In embodiments, the reactor may be operated at about atmospheric pressure.

In embodiments, the hydrocarbon feed comprising methane may be passed into the reactor. In embodiments, the hydrocarbon feed may be introduced into the reactor at a flow rate of from 5 mL/min to 200 mL/min.

In embodiments, the methane may contact the catalyst in the reactor to form a product comprising H₂. In embodiments, contacting the methane with the catalyst may form the product through one or more reaction processes, such as methane pyrolysis, steam methane reforming, dry reforming of methane, partial oxidation of methane, or autothermal reforming of methane. In embodiments, the methane may be converted to H₂ by methane pyrolysis such that, in addition to H₂, the product further comprises carbon, as shown in the below formula:

CH₄→2H₂+C

In embodiments, the product may comprise greater than or equal to 99 mol. % of the sum of H₂ and carbon. The carbon present in the product may be separated from the H₂. In embodiments, the carbon may comprise amorphous carbon, carbon nanotubes, nanofibers, or combinations thereof. The production of such carbon products may improve the economics of the methane pyrolysis process.

Producing H₂ by methane pyrolysis according to the methods described herein may reduce the production of carbon monoxide (CO) or carbon dioxide (CO₂) compared to other methods of converting methane to H₂. In embodiments, the product may comprise less than or equal to 1.0 mol. % carbon monoxide, less than or equal to 1.0 mol. % carbon dioxide, or less than or equal to 1.0 mol. % of the sum of carbon monoxide and carbon dioxide.

In embodiments, the methane may be converted to H₂ by steam methane reforming such that water is present as a reactant and such that, in addition to H₂, the product further comprises CO, as shown in the below formula:

CH₄+H₂O→3H₂+CO

In embodiments, the methane may be converted to H₂ by dry reforming of methane such that carbon dioxide is present as a reactant and such that, in addition to H₂, the product further comprises carbon monoxide, as shown in the below formula:

CH₄+CO₂→2H₂+2CO

In embodiments, the methane may be converted to H₂ by partial oxidation of methane such that oxygen gas is present as a reactant and such that, in addition to H₂, the product further comprises carbon monoxide, as shown in the below formula:

2CH₄+O₂→4H₂+2CO

In embodiments, the methane may be converted to H₂ by autothermal reforming of methane such that water and oxygen gas are present as a reactants and such that, in addition to H₂, the product further comprises carbon monoxide, as shown in the below formula:

3CH₄+H₂O+O₂→7H₂+3CO

In embodiments, the product may comprise greater than or equal to 50 mol. %, greater than or equal to 60 mol. %, or greater than or equal to 70 mol. % H₂, based on the total moles of the product.

In embodiments, the product comprising CO may be subsequently processed to produce CO₂ and additional H₂. For instance, the product may be processed in a water-gas shift convertor to convert CO and water into CO₂ and H₂. In embodiments, the H₂ may be separated from the CO₂ using methods known in the art, such as a pressure-swing adsorption unit.

In embodiments, the product may be processed to produce an H₂ stream comprising greater than or equal to 80 wt. %, greater than or equal to 85 wt. %, greater than or equal to 90 wt. %, greater than or equal to 95 wt. %, or greater than or equal to 99 wt. % H₂, based on a total weight of the H₂ stream. For instance, in embodiments, carbon may be removed from the product in a solid carbon collection unit, and the remaining product may be passed to a gas separation unit operable to produce a H₂ stream of at least 80 wt. % H₂.

This disclosure includes numerous aspects. One aspect is a method of producing H₂, the method comprising: passing a hydrocarbon feed into a reactor, wherein the hydrocarbon feed comprises at least 50 mol. % methane; contacting the methane with a catalyst in the reactor to form a product comprising H₂, wherein the catalyst comprises a support and one or more catalytically-active metals, and wherein at least 99 wt. % of the one or more catalytically-active metals are present in the catalyst as single-atoms, based on a total weight of the one or more catalytically-active metals in the catalyst.

Another aspect is any above aspect or combination of aspects, wherein the methane is converted to H₂ by methane pyrolysis such that, in addition to H₂, the product further comprises carbon.

Another aspect is any above aspect or combination of aspects, wherein the product comprises at least one of: greater than or equal to 99 mol. % of the sum of H₂ and carbon; or less than or equal to 1.0 mol. % carbon monoxide or carbon dioxide.

Another aspect is any above aspect or combination of aspects, wherein the methane is converted to H₂ by steam methane reforming such that water is present as a reactant and such that, in addition to H₂, the product further comprises carbon monoxide.

Another aspect is any above aspect or combination of aspects, wherein the methane is converted to H₂ by dry reforming of methane reforming such that carbon dioxide is present as a reactant and such that, in addition to H₂, the product further comprises carbon monoxide.

Another aspect is any above aspect or combination of aspects, wherein the methane is converted to H₂ by partial oxidation of methane such that oxygen gas is present as a reactant and such that, in addition to H₂, the product further comprises carbon monoxide.

Another aspect is any above aspect or combination of aspects, wherein the methane is converted to H₂ by autothermal reforming of methane such that water and oxygen gas are present as a reactants and such that, in addition to H₂, the product further comprises carbon monoxide.

Another aspect is any above aspect or combination of aspects, further comprising pre-treating the catalyst prior to the contacting of the catalyst with the methane.

Another aspect is any above aspect or combination of aspects, wherein the pre-treating comprises exposing the catalyst to H₂ at a temperature of from 500° C. to 700° C.

Another aspect is any above aspect or combination of aspects, wherein the pre-treating reduces the catalyst.

Another aspect is any above aspect or combination of aspects, wherein the methane is contacted with the catalyst in the reactor at a temperature of from 500° C. to 900° C.

Another aspect is any above aspect or combination of aspects, wherein the product further comprises carbon, and the carbon is separated from the H₂.

Another aspect is any above aspect or combination of aspects, wherein the support comprises a metal oxide, a mixed oxide, a carbon-based material, a metal-organic framework or combinations thereof.

Another aspect is any above aspect or combination of aspects, wherein the one or more catalytically-active metals comprise one or more of Co, Cr, Fe, Mn, Mo, Ni, Cu, Zn, Ru, Rh, Pd, Ag, Re, Ir, Pt, Pd, or Au.

Another aspect is any above aspect or combination of aspects, wherein the one or more catalytically-active metals comprise one or more of Co, Cr, Fe, Mn, Mo, Ni, Cu, Zn, Ru, Rh, Pd, Ag, Re, Ir, Pt, or Pd.

Another aspect is any above aspect or combination of aspects, wherein the catalyst comprises one or more of alkali metals, Ce, Ce₂O₃, CeO₂, Mg, MgO, Ca₂SiO₄, CaO, La, Nd, Gs, or Re.

Another aspect is any above aspect or combination of aspects, wherein the catalyst comprises from 0.1 wt. % to 20 wt. % of the one or more of alkali metals, Ce, Ce₂O₃, CeO₂, Mg, MgO, Ca₂SiO₄, CaO, La, Nd, Gs, or Re, based on a total weight of the catalyst.

Another aspect is any above aspect or combination of aspects, wherein the support comprises a plurality of defects.

Another aspect is any above aspect or combination of aspects, wherein the catalyst comprises from 1.0 wt. % to 20.0 wt. % of the one or more catalytically-active metals, based on a total weight of the catalyst.

Another aspect is any above aspect or combination of aspects, wherein the catalyst comprises from 80 wt. % to 99 wt. % of the support, based on a total weight of the catalyst.

Having described the subject matter of the present disclosure in detail and by reference to specific embodiments, it is noted that the various details described in this disclosure should not be taken to imply that these details relate to elements that are essential components of the various embodiments described in this disclosure. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

For the purposes of defining the present technology, the transitional phrase “consisting of” may be introduced in the claims as a closed preamble term limiting the scope of the claims to the recited components or steps and any naturally occurring impurities.

For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. For example, a chemical composition “consisting essentially” of a particular chemical constituent or group of chemical constituents should be understood to mean that the composition includes at least about 99.5% of a that particular chemical constituent or group of chemical constituents.

The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B and C should be interpreted as also disclosing a composition “consisting of” components A, B, and C as well as a composition “consisting essentially of” components A, B, and C.

It is also noted that recitations herein of “at least one” component, element, etc., should not be used to create an inference that the alternative use of the articles “a” or “an” should be limited to a single component, element, etc.

It should be understood that any two quantitative values assigned to a property may constitute a range of that property, and all combinations of ranges formed from all stated quantitative values of a given property are contemplated in this disclosure.

What is claimed is:

1. A method of producing H₂, the method comprising:
passing a hydrocarbon feed into a reactor, wherein the hydrocarbon feed comprises at least 50 mol. % methane;
contacting the methane with a catalyst in the reactor to form a product comprising H₂, wherein the catalyst comprises a support and one or more catalytically-active metals, and wherein at least 99 wt. % of the one or more catalytically-active metals are present in the catalyst as single-atoms, based on a total weight of the one or more catalytically-active metals in the catalyst.

2. The method of claim 1, wherein the methane is converted to H₂ by methane pyrolysis such that, in addition to H₂, the product further comprises carbon.

3. The method of claim 2, wherein the product comprises at least one of:
greater than or equal to 99 mol. % of the sum of H₂ and carbon; or
less than or equal to 1.0 mol. % carbon monoxide or carbon dioxide.

4. The method of claim 1, wherein the methane is converted to H₂ by steam methane reforming such that water is present as a reactant and such that, in addition to H₂, the product further comprises carbon monoxide.

5. The method of claim 1, wherein the methane is converted to H₂ by dry reforming of methane reforming such that carbon dioxide is present as a reactant and such that, in addition to H₂, the product further comprises carbon monoxide.

6. The method of claim 1, wherein the methane is converted to H₂ by partial oxidation of methane such that oxygen gas is present as a reactant and such that, in addition to H₂, the product further comprises carbon monoxide.

7. The method of claim 1, wherein the methane is converted to H₂ by autothermal reforming of methane such that water and oxygen gas are present as a reactants and such that, in addition to H₂, the product further comprises carbon monoxide.

8. The method of claim 1, further comprising pre-treating the catalyst prior to the contacting of the catalyst with the methane.

9. The method of claim 8, wherein the pre-treating comprises exposing the catalyst to H₂ at a temperature of from 500° C. to 700° C.

10. The method of claim 8, wherein the pre-treating reduces the catalyst.

11. The method of claim 1, wherein the methane is contacted with the catalyst in the reactor at a temperature of from 500° C. to 900° C.

12. The method of claim 1, wherein the product further comprises carbon, and the carbon is separated from the H₂.

13. The method of claim 1, wherein the support comprises a metal oxide, a mixed oxide, a carbon-based material, a metal-organic framework or combinations thereof.

14. The method of claim 1, wherein the one or more catalytically-active metals comprise one or more of Co, Cr, Fe, Mn, Mo, Ni, Cu, Zn, Ru, Rh, Pd, Ag, Re, Ir, Pt, Pd, or Au.

15. The method of claim 1, wherein the one or more catalytically-active metals comprise one or more of Co, Cr, Fe, Mn, Mo, Ni, Cu, Zn, Ru, Rh, Pd, Ag, Re, Ir, Pt, or Pd.

16. The method of claim 1, wherein the catalyst comprises one or more of alkali metals, Ce, Ce₂O₃, CeO₂, Mg, MgO, Ca₂SiO₄, CaO, La, Nd, Gs, or Re.

17. The method of claim 16, wherein the catalyst comprises from 0.1 wt. % to 20 wt. % of the one or more of alkali metals, Ce, Ce₂O₃, CeO₂, Mg, MgO, Ca₂SiO₄, CaO, La, Nd, Gs, or Re, based on a total weight of the catalyst.

18. The method of claim 1, wherein the support comprises a plurality of defects.

19. The method of claim 1, wherein the catalyst comprises from 1.0 wt. % to 20.0 wt. % of the one or more catalytically-active metals, based on a total weight of the catalyst.

20. The method of claim 1, wherein the catalyst comprises from 80 wt. % to 99 wt. % of the support, based on a total weight of the catalyst.
